(19) United States
(12) Patent Application Publication
(10) Pub. No.: US 2025/0010450 A1
(43) Pub. Date: Jan. 9, 2025

(54) SYSTEM COMPOSED OF POWER TOOL AND ENERGY SUPPLY DEVICE, AND ENERGY SUPPLY DEVICE

(71) Applicant: Hilti Aktiengesellschaft, Schaan (LI)

(72) Inventors: Bernd ZIEGLER, Schwabmuenchen (DE); Markus HARTMANN, Mauerstetten (DE); David KLINGEN, Muenchen (DE); Markus HOLUBARSCH, Landsberg am Lech (DE); Rory BRITZ, Starnberg (DE); Stefan SCHMID, Untermühlhausen (DE); Robert STANGER, Kaufbeuren (DE)

(21) Appl. No.: 18/708,789

(22) PCT Filed: Nov. 14, 2022
(86) PCT No.: PCT/EP2022/081796

§ 371 Date: May 9, 2024

(30) Foreign Application Priority Data
Dec. 1, 2021 (EP) 21211566.1
Dec. 1, 2021 (EP) 21211577.8

(51) Int. Cl. B25F 5/02; H01M 50/247; H01M 50/262

(52) U.S. Cl. CPC B25F 5/02; H01M 50/247; H01M 50/262; H01M 2220/30

(57) ABSTRACT

A system that includes a power tool and an energy supply device, wherein the power tool can be detachably connected to the energy supply device via an interface, and wherein the energy supply device and the power tool are connection partners of the interface. One of the connection partners may have a locking element, whilst the respective other connection partner has a counterpart contour as a stop for the locking element, wherein the locking element and the counterpart contour have a base material with a first density. The locking element and the counterpart contour each have a contact region with contact materials, wherein at least one of the contact materials has a second density that may be higher than the first density of the base material. An energy supply device, wherein power tools and locking elements are also disclosed in the context of the invention.

### FIELD OF THE INVENTION

The present invention relates to a system that comprises a power tool and an energy supply device, wherein the power tool can be detachably connected to the energy supply device via an interface, and wherein the energy supply device and the power tool are connection partners of the interface. In a further aspect, the invention relates to an energy supply device, wherein power tools and locking elements are also disclosed in the context of the invention.

### BACKGROUND OF THE INVENTION

The invention is located in the field of interfaces for rechargeable energy supply devices. In particular, energy supply devices for power tools are generally designed in such a way that the energy supply devices can be stored in a charging station for charging. While the energy supply device is being charged, the user can continue to operate the power tool with a further energy supply device and thus achieve work progress.

The energy supply device can be connected to the power tool via an interface if it is intended for the energy supply device to supply the power tool with electrical energy during its operation. In this working mode, the energy supply device should be held and fastened securely and stably in the power tool. Various locking mechanisms are known in the prior art for fastening the energy supply device in the power tool. If the energy supply device is to be charged, the energy supply device has to be removed from the power tool. For this purpose, means can be provided on the energy supply device or on the power tool, which means can release the locking of the energy supply device in order to enable the energy supply device to be released (“unlocking”) and removed from the power tool.

### SUMMARY OF THE INVENTION

Some of the locking mechanisms known in the prior art require a large amount of construction space. Other locking mechanisms, when actuated, open up a large opening through which, for example, dust, dirt or moisture can penetrate into the interior of the energy supply device. Yet further locking mechanisms which are known from the prior art have individual elements which do not readily interact during the locking and unlocking or which are manufactured from a material that is susceptible to wear. This can result in unnecessary wear and abrasion, wherein the wear and the abrasion may disadvantageously shorten the service life of the interface. In particular, in the prior art, interfaces and locking mechanisms are known which are produced from plastic or which constitute bent and punched parts, cast parts or die-cast parts. Such interfaces and locking mechanisms are easy to manufacture and can be inexpensively produced in large quantities.

For example, DE 10 2017 217 495 A1 discloses a storage battery pack for a power tool, wherein the storage battery pack has a rigid connecting element, such as a guide rail, which may be manufactured from a different material than the housing.

DE 10 2016 203 431 A1 relates to a storage battery pack with a cell holder for fastening the battery cells in the interior of the storage battery pack.

WO 2019 030 030 A1 describes a storage battery unit with a locking mechanism, wherein the mechanical locking mechanism can be moved into a released state by means of an unlocking button.

An object of the present invention is to overcome the defects and disadvantages of the prior art and provide an interface for connecting an energy supply device to a power tool, which interface is particularly robust with respect to wear and is durable. Furthermore, it is intended that the interface contributes to a situation in which the energy supply device can be fastened in the power tool in a functionally reliable, stable and robust manner. Further alternate or additional objectives of the invention consist in specifying a power tool, an energy supply device and a locking element, with which a robust and durable connection between energy supply device and power tool can be made possible.

The invention relates to a system that comprises a power tool and an energy supply device, wherein the power tool can be detachably connected to the energy supply device via an interface, and wherein the energy supply device and the power tool are connection partners of the interface. One of the connection partners of the interface has an element for locking the energy supply device in the power tool (“locking element”), whilst the other connection partner has a counterpart contour as a stop for the locking element. The locking element and the counterpart contour have a base material with a first density, wherein the locking element has a first contact region with a first contact material, and wherein the first contact region, in a locking position, is in contact with a second contact region of the counterpart contour of the other connection partner, wherein the second contact region has a second contact material, wherein the first contact material and/or the second contact material has a second density. In the context of the invention, this preferably means that at least one of the contact materials has a second density, wherein the second density preferably differs from the first density and is in particular greater than the first density.

It falls within the invention for the connection or locking of the connection partners of the interface, that is to say of the power tool and the energy supply device, to be realized by means of the locking element and the counterpart contour. These elements have contact materials of different density. Within the meaning of the invention, this preferably means that, in the context of the present invention, the region of the locking of the interface is reinforced using different materials, and is thus made particularly robust. The locking element and the counterpart contour are in particular not to be confused with guide rails or guide surfaces, because the locking element and the counterpart contour are elements which engage with one another as the energy supply device is connected to the power tool and which are designed correspondingly to one another, whereas guide rails or guide surfaces merely constitute planar guide elements that can facilitate the insertion of the energy supply device into a cavity of the power tool. Whilst guide rails or guide surfaces are rigid, it is the case in particular that the locking element of the present invention is movable. Guide rails or guide surfaces, on the one hand, and the locking element, on the other hand, accordingly differ in terms of their configuration (rigid or movable) and in terms of their function (guidance or locking).

The invention preferably relates to an interface for connecting an energy supply device to a power tool, wherein, in particular, the locking region of the interface may be reinforced in the sense that a locking element and/or a counterpart contour have a contact material with a greater density than the other counterpart. It is preferably an object of the invention to reinforce the locking region of the interface between energy supply device and power tool, and thus make said locking region particularly robust and durable. Said object is advantageously achieved by means of the design according to the invention of the interface or of its components “locking element” and “counterpart contour”, wherein, in particular, the reinforcement by means of different materials in the region of the locking contributes to the achievement of the object.

The invention relates in particular to a locking element that may be arranged either on the energy supply device or on the power tool. The locking element has a base material with a first density, wherein the locking element furthermore has a first contact region which, in a locking position, is in contact with a second contact region of the other connection partner. For example, the locking element may be arranged on the energy supply device. In this case, the first contact region is also part of the energy supply device, whilst the second contact region is part of the other connection partner of the interface—in this case of the power tool. The respective other connection partner of the interface—in this case the power tool—has a counterpart contour as a stop for the locking element, wherein the counterpart contour has a second contact region. In another exemplary embodiment of the invention, the locking element may be arranged on the power tool. In this case, the first contact region is also part of the power tool, whilst the second contact region, which is arranged on the counterpart contour, is part of the other connection partner of the interface—in this case of the energy supply device.

The locking element may comprise two different materials, wherein, in the context of the invention, the materials of the locking element are preferably referred to as “base material” and as “contact material”. Owing to its construction from the at least two stated materials, the locking element may preferably also be referred to in the context of the invention as “hybrid pawl” or as “locking element of hybrid design”. It has been found that, through the use of the two materials of different densities, a particularly robust, wear-resistant and durable interface for connecting an energy supply device to a power tool can be provided. In this embodiment of the invention, it is preferred that the interface has at least one locking element, wherein the locking element is arranged on one of the connection partners of the interface-energy supply device or power tool. The locking element may have a base material with a first density, wherein the locking element has a first contact region which, in a locking position, is in contact with a second contact region of the other connection partner, wherein the first contact material or the second contact material has a second density that preferably differs from the first density of the base material of the locking element. The respective other connection partner of the interface has a counterpart contour as a stop for the locking element, wherein the counterpart contour may have a second contact region. In the context of the invention, it is preferred that in each case one connection partner has a locking element, and the respective other connection partner has the counterpart contour as a stop for the locking element. Both the locking element and the counterpart contour each have a contact material, wherein at least one of the contact materials has a second density that is preferably greater than a first density of the base material of the locking element or counterpart contour. The contact material with the second density has particularly good wear resistance, such that, through the use of an interface in which at least one contact partner-locking element or counterpart contour—has a contact region with a high density or improved wear resistance, a particularly robust and durable interface can be provided. The interface by means of which the power tool and the energy supply device can be connected, and in which at least one of the contact materials of the connection partners has a second density, is referred to in the context of the invention as “reinforced interface”.

In particular, the interface satisfies elevated wear requirements that could be imposed in future—for example owing to new battery technologies-on the connection of energy supply device and power tool. This is because new battery technologies are expected to yield energy supply devices with longer service lives. For this situation, it is advantageous if the interfaces for connecting an energy supply device to a power tool can also match these longer service lives without having to be exchanged before the end of the service life of the energy supply device. With the invention, it is advantageously possible for a technical solution for connecting an energy supply device to a power tool to be provided which both exhibits high wear resistance and is also capable of ensuring high security against undesired detachment of the interface. Tests have shown that the interface with the locking element composed of at least two different materials advantageously satisfies these aims without increasing the actuation forces that the user must impart in order to unlock the energy supply device. In other words, an energy supply device with a interface remains easy to operate, and an optional actuating element that can be actuated by the user in order to unlock the energy supply device can be operated without great expenditure of force.

In the context of the invention, it may however also be preferred for the locking element to be composed of only one material, for example the base material, such that the locking element has a uniform density throughout. In this case, it is preferred that the contact region of the locking element has a contact material that does not have a density that differs from the base material. In other words, in this embodiment of the invention, the locking element may be composed of a material with a first density throughout. In this case, the locking element preferably does not have any metal inserts or metal insert parts. However, in this case, it is preferred that the connection partners of the interface with which the locking element interacts in order to establish the connection has a counterpart contour with a contact region with a contact material with a second density, wherein the second density is preferably greater than the first density of the locking element.

In the context of the invention, it may however also be preferred that both the locking element and the counterpart contour with which the locking element interacts in order to establish the connection have contact materials with a second density. If the contact material with the second density is for example metal or a metal alloy, the connection between the power tool and the energy supply device is formed by a metal-on-metal interface, which is advantageously particularly durable and wear-resistant.

In the context of the invention, it is preferred that at least one contact region of the interface has a contact material with a second density, wherein the contact region with the second density, which preferably differs from the first density, may be arranged on the power tool and/or on the energy supply device. The contact region with the second density may be formed for example by metal inserts or metal insert parts, wherein, in the context of the invention, it is preferred that at least one connection partner of the interface—power tool and/or energy supply device—has a contact region with a contact material with a second density.

If the locking element has a contact region with a contact material with a second density, it is preferred in the context of the invention that the locking element is manufactured predominantly from the base material and to a lesser extent from the contact material. The contact material may preferably have or occupy a volume within the locking element, wherein the volume of the contact material makes up a proportion in a range of less than 20%, preferably less than 10%, of a total volume of the locking element. It has been found that, in the case of such an embodiment of the locking element, a locking element can be provided which is particularly lightweight and easy to handle, wherein the locking element is nevertheless very robust and wear-resistant.

The locking element may be arranged on one of the two connection partners of the interface. In the context of the invention, it is very particularly preferred that the locking element is arranged on the energy supply device. The energy supply device may, on its top side, have a preferably plate-like structure, which, for example in a forward spatial direction, has a power and/or data interface and, in a rear spatial region, has the interface for connecting the energy supply device to the power tool. The spatial directions are illustrated in FIG. 1. It may however also be preferred that the locking element is arranged on the power tool. In order to make a linguistic distinction between the connection partners, that connection partner on which the locking element is arranged may preferably be referred to as “first connection partner”, whereas that connection partner on which the locking element is not arranged may be referred to as “second connection partner”. The locking element is preferably arranged on the first connection partner, wherein the locking element has a first contact region which, in a locking position, is in contact with a counterpart contour with a second contact region of the second connection partner, wherein the first contact region has a first contact material and the second contact region has a second contact material, wherein the first contact material or the second contact material has a second density. The locking element may preferably be arranged on the energy supply device or on the power tool, wherein a contact region with a contact material with a second density is provided on at least one of the connection partners of the interface. Correspondingly, the counterpart contour may be arranged on the power tool or on the energy supply device, wherein at least one of the contact materials has a second density.

If the contact material with a second density is provided on the locking element, the contact material may preferably be provided on contact surfaces of the locking element, wherein the contact surfaces of the locking element are oriented in the direction of that connection partner on which the locking element is not arranged. In other words, the contact surfaces of the locking element are oriented in the direction of the second connection partner or of the counterpart contour thereof. If the locking element is arranged on the energy supply device, for example, the contact surfaces of said locking element are preferably oriented in the direction of the power tool, whereas the contact surfaces are preferably oriented in the direction of the energy supply device if the locking element is arranged on the power tool. In the context of the invention, the wording “to be oriented in a direction” preferably means that the contact surfaces are oriented so as to face toward the other connection partner. For example, the contact surfaces may be arranged on a protruding region of the locking element, wherein said protruding region of the locking element, in the locking situation, engages with a preferably corresponding recess of the second connection partner. If the locking element is for example part of the energy supply device, the locking element may, in the locking situation, engage with a preferably corresponding recess of the second connection partner, in this case of the power tool. The recess may be an example for the counterpart contour of the second connection partner. In the context of the invention, it may however also be preferred that the locking element is for example part of the power tool, and the locking element, in the locking situation, engages with a preferably corresponding recess or counterpart contour of the energy supply device.

In the context of the invention, it is preferred that the contact surfaces form a contact region of the locking element, wherein, in particular, said contact region of the locking element has a contact material with a second density. The locking element may preferably have, in its base material, depressions that are configured to receive inserts or insert parts composed of a second material, the contact material. In the context of the invention, it is very particularly preferred that those regions of the locking element which come into contact with the second connection partner when the energy supply device is connected to the power tool are formed from the contact material or comprise said contact material. This is because the contact material may preferably have a greater density and thus advantageously also better wear resistance than the base material, which in the context of the invention is preferably also referred to as first material. In the context of the invention, it is preferred that the second density, that is to say the density of the contact material, is greater than the first density, that is to say the density of the base material of the locking element. It is preferable for in particular those regions of the locking element which make contact with the second connection partner when the energy supply device is connected to the power tool to comprise the contact material with the second density, which has a different density than the base material, and advantageously greater wear resistance. In this way, the wear resistance and robustness of the locking element as a whole can be greatly increased, because a wear-resistant material is used in particular at the mechanically particularly highly loaded contact regions. It is advantageously thus possible to provide a particularly robust and durable interface, which exhibits low wear, for connecting the energy supply device to the power tool.

In the context of the invention, it may also be preferred that the contact surfaces are provided on that connection partner of the interface on which the locking element is not arranged. In other words, the contact surface may be provided on that connection partner of the interface which comprises the counterpart contour as a stop of the locking element. Said connection partner of the interface may preferably also be referred to in the context of the invention as “opposite connection partner”. In this embodiment of the invention, it is preferred that the contact surfaces are provided on the opposite connection partner and form a contact region, wherein said contact region has a contact material with a second density. The opposite connection partner may preferably have depressions that are configured to receive inserts or insert parts composed of a second material, the contact material. In the context of the invention, it is very particularly preferred that those regions of the opposite connection partner which, when the energy supply device is connected to the power tool, come into contact with the connection partner that has the locking element are formed from the contact material or comprise said contact material. This is because the contact material may preferably have a greater density, and thus advantageously also better wear resistance, than a base material of the opposite connection partner. In the context of the invention, it is preferred that the second density, that is to say the density of the contact material, is greater than the first density. In this embodiment of the invention, it is preferable for in particular the contact surfaces to comprise the contact material with the second density, wherein the contact surfaces of the opposite connection partner, or the contact region thereof, thus advantageously have greater wear resistance. In this way, the wear resistance and robustness of the interface as a whole can be greatly increased, because a wear-resistant material is used in particular at the mechanically particularly highly loaded contact regions. It is advantageously thus possible to provide a particularly robust and durable interface, which exhibits low wear, for connecting the energy supply device to the power tool.

It is preferred in the context of the invention that the second density, that is to say the density of the contact material, lies in a range of greater than 3.0 g/cm³, preferably greater than 4 g/cm³. The materials that may be used for forming the contact region may for example be metals or metal alloys. In the context of the invention, it may be very particularly preferred that the contact material that has a second density has a metal, a metal alloy and/or a metal coating as contact material.

For example, inserts or insert parts composed of metal or a metal alloy as contact material with a second density may be used, and inserted into depressions within the base material of the locking element. The inserts or insert parts composed of metal or a metal alloy may for example be manufactured from sheet metal or comprise sheet metal, wherein, in the context of the invention, the term “sheet metal” is preferably to be understood to mean “a rolled product comprising metal or a metal alloy”. The high density of the contact material preferably leads to the high wear resistance in the contact region of the locking element and thus advantageously to a longer service life of the interface that comprises such a locking element. For example, nickel (Ni) may be used as metal. In the context of the invention, it is preferred that the contact materials with a second density have a PREN value of greater than 10, wherein the PREN value may preferably be greater than 13 and most preferably greater than 15. The abbreviation PREN preferably stands for the “Pitting Resistance Equivalent Number”, and represents a measure for corrosion resistance of a material.

It is preferred in the context of the invention that the first density, that is to say the density of the base material, lies in a range of less than 3.0 g/cm³, preferably less than 2 g/cm³. The materials that may be used for the base material may for example be plastics. The low density of the base material advantageously has the effect that a particularly lightweight interface for connecting the energy supply device to the power tool can be provided. Furthermore, materials with a density of less than 2 g/cm3 constitute particularly inexpensive solutions for producing the interface or the locking element.

In the context of the invention, it may be preferred that, to produce the inserts or the insert parts, sheet-metal parts are placed into an injection-molding tool and are encapsulated with a material of relatively low density by injection molding. The material of relatively low density may preferably be the base material of the interface, that is to say preferably a plastics material. In the context of the invention, it may also be preferred that both the power tool and the energy supply device comprise a base material, wherein the base materials of the power tool and/or of the energy supply device may differ slightly from one another. In the context of the invention, it is preferred that relatively small deviations in the base materials of the connection partners of the interface are not regarded as materials of different density. Relatively small deviations, for example in the composition of the base material, if it is for example a plastics material, are also regarded in the context of the invention as base materials with a first density that is preferably lower than a second density of the first or of the second contact material. Preferably, the first density, that is to say the density of the base material, may lie in a range of less than 3.0 g/cm³, preferably less than 2 g/cm³, whereas the second density lies in a range of greater than 3.0 g/cm³, preferably greater than 4 g/cm³.

In the context of the invention, it is preferred that a surface hardness of the contact material that has a second density lies in a range of greater than 90 HV, preferably in a range of greater than 100 HV, wherein the unit “HV” preferably represents a Vickers hardness test of the contact material. Tests have shown that in particular contact materials with a Vickers hardness of greater than 100 HV can lead to particularly wear-resistant and robust interfaces and locking elements.

If the contact region with the contact material with the second density is arranged on the locking element, it may be preferred in the context of the invention that the locking element has a protruding region, wherein said protruding region, in the locking situation, entirely or partially makes contact with the second connection partner of the interface. The protruding region may for example be made up of the contact region and other regions, wherein the other regions may for example be set-back regions which, in the locking situation, do not make direct contact with the second contact partner of the interface. The protruding region may preferably form an overall contact region, wherein, in the context of the invention, it is preferred that the contact region makes up a proportion in a range of more than 60%, preferably more than 70%, of the overall contact region. Preferably, that proportion of the overall contact region which is made up by the contact region lies in a range of greater than 60%, preferably greater than 70%. In the context of the invention, this preferably means that the other regions of the protruding region make up less than 40%, preferably less than 30%, of the protruding region. In the context of the invention, it is preferred that the contact region is arranged so as to be oriented in the direction of the other connection partner. By virtue of the fact that the contact material preferably makes up more than 70% of the overall contact region of the locking element, the main contact between the locking element and the second connection partner preferably takes place predominantly between the contact material with the second density and the other connection partner. Since the contact material with the second density is particularly wear-resistant, it is possible in this way to provide a particularly durable interface for connecting the energy supply device to the power tool. The advantages of the invention, such as increased wear resistance and longer interface service life, are realized in particular if the contact region makes up a proportion in a range of more than 70% of said overall contact surface of the locking element. For example, if a locking element has four individual contact regions and each contact surface has a surface area of 2.5 cm², the overall area of the contact region is 10 cm². If the protruding region has an overall area, that is to say an overall contact region, of 12 cm², the contact region would in this example make up a proportion of 10/12=83% of the overall area or of the overall contact region. If the protruding region has an overall area, that is to say an overall contact region, of 18 cm², the above condition that the contact region makes up a proportion of more than 70% of the overall contact region is not satisfied, because 10/18=55.55%<70%. The contact surfaces may for example have an overall contact surface in a range from 50 to 100 mm².

If the contact region with the contact material with the second density is arranged on the locking element, it may be preferred in the context of the invention that the contact material has or occupies a volume, wherein the volume of the contact material makes up a proportion in a range of less than 20%, preferably less than 10%, of a total volume of the locking element. In this way, a particularly lightweight locking element can be provided, wherein an interface with such a locking element is however surprisingly robust and durable owing to the contact material with the second density.

In the context of the invention, it is preferred that the interface has not only the locking element but also an element for actuation by a user, wherein the locking element and the actuation element form a locking mechanism. The locking element and/or the actuation element may be mounted rotatably about at least one spatial axis, wherein the spatial axes or axes of rotation run through pivot points of the locking element and/or of the actuation element. In the context of the invention, it is preferred that the pivot point or the axis of rotation of the at least one locking element of the interface precedes a locking location in an insertion direction.

In the context of the invention, it is preferred that the system has more than one power tool and more than one energy supply device, wherein the power tools and the energy supply device may have different combinations of the arrangements of locking element and counterpart contour or of the contact materials. In the context of the invention, it is preferred that two system constituents that are connected to one another in the context of the invention are designed correspondingly with respect to one another in the sense that in each case one connection partner has a locking element and the other connection partner has the counterpart contour for the abutment of the locking element. Both the locking elements and the counterpart contours may be arranged both on the power tool and on the energy supply device. Furthermore, it is also possible for the at least one contact material with the second density to be arranged on one of the connection partners of the interface, wherein the at least one contact material with the second density may be arranged both in the region of the locking element and in the region of the counterpart contour. In the context of the invention, it is preferred that, in particular, the combinations plastic/metal, metal/plastic, metal/metal are used as contact materials of the contact regions of the power tool and of the energy supply device.

In the context of the invention, it is very particularly preferred that the system has a second power tool and/or a second energy supply device, wherein the second power tool and the second energy supply device are designed correspondingly to the first power tool and the first energy supply device in terms of a presence of counterpart contour and locking element, wherein the second power tool has a contact material and the second energy supply device has a contact material, wherein the contact materials of the second power tool and of the second energy supply device have the respective other of the two densities in relation to the first power tool and the first energy supply device. The system may preferably have either a combination of two power tools and one energy supply device or a combination of two energy supply devices and one power tool or a combination of two energy supply devices and two power tools. Here, the first power tool and the first energy supply device have contact materials, of which at least one contact material has a second density. One of the two first connection partners, that is to say either the first power tool or the first energy supply device, has a locking element, wherein the respective other first connection partner of the system has a counterpart contour. If the first power tool has a counterpart contour, it is preferred in the context of the invention that the second power tool also has a counterpart contour. In the context of the invention, this relationship can preferably be described by the statement that the second power tool is designed correspondingly to the first power tool in terms of a presence of counterpart contour and locking element. If the first power tool has a locking element, it is preferred in the context of the invention that the second power tool also has a locking element. In the context of the invention, this relationship can preferably be described by the statement that the second power tool is designed correspondingly to the first power tool in terms of a presence of counterpart contour and locking element. If the first energy supply device has a locking element, it is preferred in the context of the invention that the second energy supply device also has a locking element. In the context of the invention, this relationship can preferably be described by the statement that the second energy supply device is designed correspondingly to the first energy supply device in terms of a presence of counterpart contour and locking element. If the first energy supply device has a counterpart contour, it is preferred in the context of the invention that the second energy supply device also has a counterpart contour.

In the context of the invention, it is preferred that the second power tool and the second energy supply device each have a contact material, wherein the contact materials of the second power tool and of the second energy supply device have the respective other of the two densities. In the context of the invention, this preferably means that the second power tool or the second energy supply device has a contact material with the second density if a contact material of the first power tool or of the first energy supply device has a first density. Correspondingly, the second power tool or the second energy supply device may have a contact material with the first density if a contact material of the first power tool or of the first energy supply device has a second density. It is ensured in this way that the power tools and the energy supply devices of the system are of mechanically corresponding design, in the sense that the connection partners for connection respectively fit together. This is ensured by virtue of the power tools either all having a locking element or all having a counterpart contour. Furthermore, the energy supply devices either all have a locking element or all have a counterpart contour, wherein in each case one group of connection partners, for example the power tools, have the counterpart contours, whereas the other group of connection partners, for example the energy supply devices, have the locking elements. In the context of the invention, the term “the two densities” is used to mean the first density and the second density of the contact materials such as may be provided on the connection partners of the system. The wording “the other of the two densities” thus refers to the second density if the contact material in the comparison case has a first density. The wording “the other of the two densities” thus preferably refers to the first density if the contact material in the comparison case has a second density.

Furthermore, through the assignment of the densities of the contact materials, it is achieved that in each case one power tool with a contact material with a first density and with a contact material with a second density is present in the system. Furthermore, a system can be provided in which in each case one energy supply device with a contact material with a first density and with a contact material with a second density is present. In this way, a particularly flexible energy supply platform for power tools can be provided, with which a selection of the energy supply devices can be made optimally with regard to the electrical and/or mechanical demands and requirements of the power tool.

In the context of the system, it is possible in particular for energy supply devices with high constant currents for the supply of energy to the power tool to be used as energy supply devices. These energy supply devices can be connected via an interface according to the invention to a preferably high-powered power tool, wherein the interface is characterized by at least one contact region with a contact material with a second density. In this way, a particularly flexible system or a platform for supplying energy to a power tool can be provided. The advantages, technical effects and definitions that have been described for the system preferably apply to an energy supply device that is described below. The system is thus particularly highly suitable for the transition to new and improved battery technologies.

Through the use of the reinforced interface, the system can be used to provide a particularly powerful interface for the connection for a power tool and an energy supply device, wherein the power tool may preferably be a particularly high-powered power tool, such as a demolition apparatus, a percussion drill, a chisel or a core drill, whereas the energy supply device is preferably an energy supply device that is configured to output constant currents in a range of greater than 50 amperes (A), preferably greater than 70 A, most preferably greater than 100 A, to the power tool. Consequently, with the reinforced interface, a future-proof power tool system can be provided because the interface for connecting the energy supply device to the power tool is particularly robust and durable, such that the stringent service life requirements imposed on new battery technologies can be satisfied particularly effectively. In particular, with the invention, a system can be provided which optimally supports the transmission of high constant currents, such that the technical advantages of future battery technologies can be particularly efficiently utilized without damage occurring to the devices. In particular, it is thus possible for the possibilities that future cell and/or battery technologies bring with them to be particularly effectively utilized and made productive for the system.

In a further aspect, the invention relates to an energy supply device for use in the system, wherein the energy supply device can be connected to a power tool via an interface for the transmission of electrical energy. The energy supply device has an energy supply device contact region with an energy supply device contact material, wherein the energy supply device contact region is provided on a locking element or on a counterpart contour, wherein the locking element and the counterpart contour have a base material with a first density, wherein the energy supply device contact material has a second density.

It is preferred in the context of the invention that the energy supply device may comprise a locking element with a first contact region, wherein the first contact region comprises a first contact material, wherein the first contact material has a second density. The locking element has a base material with a first density, wherein the first density is preferably lower than the second density. The locking element may preferably comprise inserts or insert parts composed of metal or a metal alloy, wherein said insert parts or inserts preferably have a greater density than the base material of the first density, which may preferably be a plastics material. In the context of the invention, provision may also be made for the energy supply device to have a counterpart contour as a stop for the locking element with a second contact region, wherein the second contact region of the counterpart contour has a second contact material, wherein the second contact material has a second density. The counterpart contour also has a base material with a first density, wherein the first density is preferably lower than the second density. The counterpart contour may comprise inserts or insert parts composed of metal or a metal alloy, wherein said insert parts or inserts preferably have a greater density than the material of the first density, which may preferably be a plastics material. Tests have shown that, with the and the provision of a contact material with a second density, a robust and durable energy supply device can be provided. In the context of the invention, it is preferred that the energy supply device can be used in the system. The energy supply device is preferably configured to output constant currents in a range of greater than 50 amperes (A), preferably greater than 70 A, and most preferably greater than 100 A, to the power tool.

The energy supply device may, for example, be based on the new and improved battery technologies and have a service life of at least 600 charging cycles. This preferably corresponds to a capacity throughput of at least 100 Ah/cm³ (capacity/cell volume) with a simultaneous loss of capacity of less than 30% after 600 charge/discharge cycles. If such an energy supply device is used to supply electrical energy to a power tool, the interface can be used to carry out more than the hitherto conventional 2500 plug-in or connection cycles between the energy supply device and the power tool without significant wear occurring at the interface. The invention therefore particularly readily meets the future requirements for interfaces that result from the new and improved battery technologies, and particularly robust, powerful, and wear-resistant interfaces for connecting an energy supply device to a power tool can advantageously be provided.

The invention is thus capable of ensuring both high wear resistance and high security against detachment owing to acceleration forces, without increasing the actuating force for manual detachment of the interface. Such energy supply devices can preferably have a capacity throughput of at least 100 Ah/cm³ (capacity/cell volume) with a simultaneous loss of capacity of less than 30% after 600 charge/discharge cycles. The platform concept furthermore allows joint use of interfaces with different contact materials, and the use of hybrid linear guides. It is thus possible, advantageously without modification of the interface of the other connection partner, to use the more expensive hybrid linear guides in particular in the case of energy supply devices that have a high service life capacity density. In the case of energy supply devices that have a relatively low service life capacity density, use may advantageously be made of less expensive interfaces with contact materials with a first density. The more expensive hybrid pawls may advantageously be used in particular in the case of power tools that are subject to stringent service life requirements, preferably without significant modification of the interface of the other connection partner. Furthermore, power tools that are subject to less stringent service life requirements may advantageously be equipped with less expensive interfaces with contact materials of a first density.

The improvements in terms of robustness and service life are particularly advantageous because it is becoming apparent that the service lives of rechargeable batteries and storage batteries could become longer owing to improved battery technologies. It will therefore be welcomed by experts if the present invention can be used to provide an interface solution for an energy supply device, in particular for connection to a power tool, which does justice to the longer service life of the future energy supply device.

It is preferred in the context of the invention that the energy supply device comprises at least one energy storage cell, which is referred to as “cell” in the context of the invention. The at least one cell has an internal resistance DCR_I of less than 10 milliohms (mohm). In preferred embodiments of the invention, the internal resistance DCR_I of the at least one cell may be less than 8 milliohms and preferably less than 6 milliohms. Here, the internal resistance DCR_I is preferably measured in accordance with standard IEC61960. The internal resistance DCR_I represents, in particular, the resistance of a cell of the energy supply device, wherein any components or accessories of the cell do not make any contribution to the internal resistance DCR_I. A low internal resistance DCR_I is advantageous, as this means that unwanted heat that needs to be dissipated does not arise at all. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, it is possible to provide an energy supply device which has particularly good thermal properties in the sense that it can be operated particularly well at low temperatures, wherein the expenditure on cooling can be kept surprisingly low. In particular, an energy supply device with an internal cell resistance DCR_I of less than 10 milliohms is particularly well suited to supplying electrical energy to particularly high-powered power tools. Such energy supply devices can therefore make a valuable contribution to allowing storage-battery-operated power tools to be used even in areas of application that those skilled in the art previously assumed were not open to storage-battery-operated power tools.

Advantageously, such an energy supply device can be used to allow a battery-operated or storage-battery-operated power tool having an energy supply device according to the invention to be supplied with a high level of output power over a long period of time without damaging the surrounding plastics components or the cell chemistry within the cells of the energy supply device.

It is preferred in the context of the invention that a ratio of a resistance of the at least one cell to a surface area A of the at least one cell is less than 0.2 millionm/cm², preferably less than 0.1 millionm/cm² and most preferably less than 0.05 milliohm/cm². In the case of a cylindrical cell, the surface area of the cell may be formed for example by the outer surface of the cylinder as well as the top side and the bottom side of the cell. Furthermore, it may be preferred in the context of the invention that a ratio of a resistance of the at least one cell to a volume V of the at least one cell is less than 0.4 millionm/cm³, preferably less than 0.3 milliohm/cm³ and most preferably less than 0.2 millionm/cm³. For conventional geometric shapes, such as cuboids, cubes, spheres or the like, a person skilled in the art knows the formulae for calculating the surface area or the volume of such a geometric body. In the context of the invention, the term “resistance” preferably denotes the internal resistance DCR_I which can preferably be measured in accordance with standard IEC61960. This is preferably a DC resistance.

It is preferred in the context of the invention that the at least one cell has a heating coefficient of less than 1.0 W/(Ah·A), preferably less than 0.75 W/(Ah·A) and particularly preferably less than 0.5 W/(Ah·A). Furthermore, the at least one cell may be designed to output a current of greater than 1000 amperes/liter substantially constantly. The discharge current is indicated in relation to the volume of the at least one cell, wherein the space measurement unit “liter” (I) is used as the unit for the volume. The cells according to the invention are therefore able to output a discharge current of substantially constantly greater than 1000 A per liter of cell volume. In other words, a cell with a volume of 1 liter is able to output a substantially constant discharge current of greater than 1000 A, wherein the at least one cell furthermore has a heating coefficient of less than 1.0 W/(Ah·A). In preferred embodiments of the invention, the at least one cell of the energy supply device may have a heating coefficient of less than 0.75 W/(Ah·A), preferably less than 0.5 W/(Ah·A). The unit for the heating coefficient is watts/(ampere hours·amperes). The heating coefficient may of course also have intermediate values, such as 0.56 W/(Ah·A); 0.723 W/(Ah·A) or 0.925 W/(Ah·A).

The invention advantageously allows the provision of an energy supply device having at least one cell which exhibits reduced heating and which is therefore particularly well suited to providing a supply to power tools in which high power levels and high currents, preferably constant currents, are desired for operation. In particular, the invention can be used to provide an energy supply device for a power tool in which the heat that may be generated during operation of the power tool and when outputting electrical energy to the power tool can be dissipated in a particularly simple and uncomplicated manner. Tests have shown that the invention can not only be used to more effectively dissipate existing heat. Rather, the invention prevents heat from being generated, or the quantity of heat generated during operation of the power tool can be considerably reduced using the invention. The invention can advantageously be used to provide an energy supply device which can supply electrical energy in an optimum manner primarily also to power tools that impose stringent requirements in respect of power and discharge current. In other words, the invention can provide an energy supply device for particularly high-powered power tools with which, for example, heavy drilling or demolition work can be performed on construction sites.

In the context of the invention, the term “power tool” is to be understood to mean a typical device that can be used on a construction site, for example a building construction site and/or a civil engineering construction site. These may be hammer drills, chisels, core drills, angle or cut-off grinders, cutting devices or the like, without being restricted thereto. In addition, auxiliary devices such as those occasionally used on construction sites, such as lamps, radios, vacuum cleaners, measuring devices, construction robots, wheelbarrows, transport devices, feed devices or other auxiliary devices, can be “power tools” in the context of the invention. The power tool may in particular be a mobile power tool, wherein the energy supply device may also be used in particular in stationary power tools, such as frame-mounted drills or circular saws. However, preference is given to hand-held power tools that are, in particular, operated using a storage battery or battery.

It is preferred in the context of the invention that the at least one cell has a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say connected to a power tool. In particular, energy supply devices with temperature cooling half-lives of less than 8 minutes have been found to be particularly suitable for use with high-powered power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging remains within the at least one cell only for a short time. In this way, the cell can be recharged particularly quickly and is rapidly available for re-use in the power tool. Moreover, the thermal load on the components of the energy supply device or of the power tool having the energy supply device can be considerably reduced. As a result, the energy supply device can be preserved and its service life extended.

In the context of the invention, it is preferred that the at least one cell is arranged in a battery pack of the energy supply device. A series of individual cells can preferably be combined in the battery pack and in this way inserted into the energy supply device in an optimum manner. For example, 5, 6 or 10 cells may form a battery pack, with integer multiples of these numbers also being possible. For example, the energy supply device may have individual cell strings, which may comprise, for example, 5, 6 or 10 cells. An energy supply device having, for example, three strings of five cells each may comprise, for example, 15 individual cells.

In the context of the invention, it is preferred that the energy supply device has a capacity of at least 2.2 Ah, preferably at least 2.5 Ah. Tests have shown that the capacity values mentioned are particularly well suited to the use of high-powered power tools in the construction industry and satisfy the requirements there for the availability of electrical energy and the possible service life of the power tool particularly well.

The at least one cell of the energy supply device is preferably configured to output a discharge current of at least 20 A for at least 10 s. For example, a cell of the energy supply device may be designed to provide a discharge current of at least 20 A, in particular at least 25 A, for at least 10 s. In other words, the at least one cell of an energy supply device may be configured to provide a continuous current of at least 20 A, in particular at least 25 A.

It is also conceivable that peak currents, in particular short-term peak currents, may lead to intense heating of the energy supply device. Therefore, an energy supply device with powerful cooling, as can be achieved by the measures described here, is particularly advantageous. It is conceivable, for example, that the at least one cell of the energy supply device can provide at least 50 A for 1 second. In other words, it is preferred in the context of the invention that the at least one cell of the energy supply device is configured to provide a discharge current of at least 50 A for at least 1 s. Power tools can often require high levels of power for short time periods. An energy supply device with cells able to output such a peak current and/or such a continuous current may therefore be particularly suitable for high-powered power tools such as are used on construction sites.

It is preferred in the context of the invention that the at least one cell comprises an electrolyte, wherein the electrolyte is preferably present in a liquid physical state at room temperature. The electrolyte can comprise lithium, sodium and/or magnesium, without being restricted thereto. In particular, the electrolyte may be lithium-based. As an alternative or in addition, said electrolyte can also be sodium-based. It is also conceivable for the storage battery to be magnesium-based. The electrolyte-based energy supply device may have a rated voltage of at least 10 V, preferably at least 18 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto.

It is preferred in the context of the invention that the energy supply device is charged, for example, at a charging rate of 1.5 C, preferably 2 C, and most preferably 3 C. A charging rate of xC can be understood as meaning the current intensity which is required to fully charge a discharged energy supply device in a fraction of an hour corresponding to the numerical value x of the charging rate x C. For example, a charging rate of 3 C makes it possible to fully charge the storage battery within 20 minutes.

It is preferred in the context of the invention that the at least one cell of the energy supply device has a surface area A and a volume V, wherein a ratio A/V of surface area to volume is greater than six times, preferably eight times, and particularly preferably ten times, the reciprocal of the cube root of the volume.

The wording that the surface A of the at least one cell is greater than for example eight times the cube root of the square of the volume V can preferably also be expressed by the formula A>8*V\hat{ }(2/3). Written another way, this relationship can be described by the fact that the ratio A/V of surface area to volume is greater than eight times the reciprocal of the cube root of the volume.

To check whether the above relation is satisfied, values in the same basic unit must always be used. For example, if a value for the surface area in m² is inserted into the above formula, a value in the unit m³ is preferably inserted for the volume. For example, if a value for the surface area in the unit cm² is inserted into the above formula, a value in the unit cm³ is preferably inserted for the volume. For example, if a value for the surface area in the unit mm² is inserted into the above formula, a value in the unit mm³ is preferably inserted for the volume.

Cell geometries which, for example, satisfy the relationship

A>8*V\hat{ }(2/3)

advantageously have a particularly favorable ratio between the outer surface of the cell, which is critical for the cooling effect, and the cell volume. The inventors have recognized that the ratio of surface area to volume of the at least one cell of the energy supply device has an important influence on the removal of heat from the energy supply device. The improved cooling capability of the energy supply device can advantageously be achieved by increasing the cell surface area given a constant volume and a low internal resistance of the at least one cell. In the context of the invention, it is preferred that a low cell temperature with a simultaneously high power output can preferably be made possible if the internal resistance of the cell is reduced. Reducing the internal resistance of the at least one cell can result in less heat being generated. In addition, a low cell temperature can be achieved by using cells in which the surface area A of at least one cell within the energy supply device is greater than six times, preferably eight times, and particularly preferably ten times, the cube root of the square of the volume V of the at least one cell. It is thus possible in particular for the release of heat to the surroundings to be improved.

It has been found that energy supply devices whose cells satisfy the stated relationship can be cooled significantly more effectively than previously known energy supply devices having, for example, cylindrical cells. The above relationship can be satisfied, for example, by virtue of the fact that, although the cells of the energy supply device have a cylindrical basic shape, additional elements that increase the surface area are arranged on the surface thereof. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cubic basic shape. The term “substantially” is not unclear to a person skilled in the art here because a person skilled in the art knows that, for example, a cuboid with indentations or rounded corners and/or edges is also intended to fall under the term “substantially cuboidal” in the context of the present invention.

It is preferred in the context of the invention for the at least one cell to have a cell core, wherein there is no point within the cell core that is more than 5 mm away from a surface of the energy supply device. When the energy supply device is being discharged, for example when it has been connected to a power tool and work is being performed with the power tool, heat may be generated in the cell core. In this specific embodiment of the invention, this heat can be transported on a comparatively short path as far as the surface of the cell of the energy supply device. The heat can be dissipated in an optimum manner from the surface. Therefore, such an energy supply device can exhibit good cooling, in particular comparatively good self-cooling. The time period until the limit temperature is reached can be extended and/or the situation of the limit temperature being reached can advantageously be entirely avoided. As a further advantage of the invention, a relatively homogeneous temperature distribution can be achieved within the cell core. This can result in uniform aging of the storage battery. This can in turn extend the service life of the energy supply device.

It is preferred in the context of the invention for the at least one cell to have a maximum constant current output of greater than 20 amperes, preferably greater than 30 amperes, most preferably greater than 40 amperes. The maximum constant current output is the quantity of current in a cell or an energy supply device that can be drawn without the cell or the energy supply device reaching an upper temperature limit. Possible upper temperature limits may lie in the region of 60° C. or 70° C., without being restricted thereto. The unit for the maximum constant current output is amperes.

In the case of all value ranges mentioned in the context of the present invention, it is always intended that all intermediate values are also considered to be disclosed. For example, in the case of the maximum constant current output, it is intended that values of between 20 and 30 A, that is to say 21, 22.3, 24, 25.55 or 27.06 amperes etc., for example, are also considered to be disclosed. Furthermore, it is intended that values of between 30 and 40 A, that is to say 32, 33.3, 36, 38.55 or 39.07 amperes etc., for example, are also considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here renders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating high-powered power tools in the construction industry. For example, the discharge currents can lie in a range of greater than 40 amperes, preferably greater than 60 amperes or even more preferably greater than 80 amperes.

In the context of the invention, it is preferred that the cell has a cell temperature gradient of less than 10 Kelvin. The cell temperature gradient is preferably a measure of temperature differences within the at least one cell of the energy supply device, wherein it is preferred in the context of the invention that the cell has a temperature distribution that is as uniform as possible, that is to say that a temperature in an inner region of the cell differs as little as possible from a temperature which is measured in the region of a lateral or outer surface of the cell.

It is preferred in the context of the invention that an energy supply device with the properties mentioned represents a powerful energy supply device, such as is referred to in the context of the present invention as an energy supply device of the first type, for example. Such energy supply devices are preferably configured to supply electrical energy to particularly high-powered power tools. The energy supply devices with the features mentioned preferably represent energy supply devices which can be regarded as representatives of future cell technologies.

In the context of the invention, it may be preferred that the locking element is part of the energy supply device. In this embodiment of the invention, the energy supply device may have at least one element for locking (“locking element”) the energy supply device in the power tool, wherein the at least one locking element is mounted rotatably about at least one spatial axis, wherein the spatial axis runs through a pivot point of the at least one locking element, wherein the pivot point of the at least one locking element precedes a locking location in an insertion direction. In the context of the invention, this preferably means that the pivot point of the locking element is arranged upstream of a locking location in an insertion direction. In other words, a locking location can be defined at which the energy supply device is locked within the power tool, wherein this location may be defined for example by an undercut or an indentation. The undercut or the indentation can receive the locking element when the locking element is rotated, and therefore changes its position, in order to lock the energy supply device. It may be preferred in the context of the invention that a distance A is defined, which indicates the distance between the locking location and the pivot point of the locking element. The distance A is shown in the figures. The locking mechanism is advantageously based on a rotational mounting of the elements involved, and therefore an ergonomically unfavorable linear movement of the elements involved can advantageously be dispensed with.

By providing the pivot point of the at least one locking element in an insertion direction upstream of a locking location, a particularly space-saving locking mechanism can be provided for an energy supply device. With the locking mechanism, it is advantageously the case that no opening on an outer wall, through which dust, dirt or moisture can enter an interior space of the energy supply device, arises during the unlocking or during the locking. This effectively protects the energy supply device from external influences. In particular, the energy supply device is able to accommodate high locking forces resulting from high accelerations. In addition, with the invention, good handling of the energy supply device can be ensured even under construction site conditions. In particular, the energy supply device is robust, durable and compact.

The preceding pivot point of the locking element has the further advantage that, under construction site conditions, rotatably mounted components are more robust, less sensitive to dust and can be moved with less play and more easily. For an ideal flow of forces, the pivot point of the rotatably mounted locking element is arranged upstream of the locking location in the insertion direction, since the locking element and the support of the locking element are subjected to a compressive load. It is preferred in the context of the invention that the insertion direction corresponds to a relative movement of energy supply device and power tool during the insertion and removal of the energy supply device.

If the energy supply device is to be connected to the power tool in order to supply the power tool with electrical energy, the energy supply device can be inserted into a cavity in the power tool, for example. In the context of the invention, it may also be preferred that the energy supply device is fastened to an underside or a side wall of the power tool. If the power tool has a cavity for receiving the energy supply device, this cavity is preferably cuboidal, with one side of the cavity usually being open. This open side of the cavity may preferably be referred to as “the rear side of the cavity”. In addition to the open side, the preferably shaft-like cavity can have a top side, an underside, a front side and two side walls. It is preferably the case that the top side and the underside, the two side walls, and the front side and the open side, of the cavity are on opposite sides of the cavity, i.e. the sides mentioned are in each case situated opposite one other.

The open side of the cavity is preferably the insertion opening for the energy supply device. This means that the energy supply device can be introduced through said insertion opening into the power tool or into the cavity provided for it. In the context of the present invention, an insertion direction can be defined which corresponds to the direction in which the energy supply device is introduced into the power tool. This means that the insertion direction extends, starting from the insertion opening, in the direction of the front side of the preferably shaft-like cavity of the power tool. This insertion direction preferably coincides with a first axis of a virtual coordinate system which is used to describe the invention (cf. figures). It is preferred in the context of the invention that a second axis of the virtual coordinate system extends between an underside and a top side of the cavity for receiving the energy supply device, while a third axis of the virtual coordinate system extends between the side surfaces of the receiving shaft for the energy supply device. The axes of the virtual coordinate system are preferably perpendicular to one another, wherein the first axis corresponds to the x-axis of a known coordinate system (forward and back), the second axis corresponds to the y-axis (up and down), and the third axis corresponds to the z-axis (out of and back into the image plane). Within the meaning of the virtual coordinate system, the front side of the cavity of the power tool in the insertion direction represents a front region of the energy supply device, because the front side of the cavity is the target, as it were, of the insertion movement. By contrast, the open side of the cavity is a rear side of the cavity.

In the context of the invention, it is preferred that the side walls and side surfaces of the energy supply device are designed to correspond to the walls of the cavity of the power tool. In the context of the invention, the corresponding design of the side walls and side surfaces of the energy supply device on the one hand and of the walls of the cavity of the power tool on the other hand preferably means that the walls in each case have substantially planar surfaces, so that the energy supply device can be introduced particularly easily and securely into the cavity of the power tool. In particular, the side walls and side surfaces of the energy supply device and the walls of the cavity of the power tool do not have protruding regions or elements which could constitute an obstacle on insertion of the energy supply device into the power tool.

The energy supply device preferably has a cuboidal basic shape, wherein the energy supply device has in particular a top side and an underside, a front side and a rear side, and two side surfaces. While the side surfaces of the energy supply device may be designed to be substantially identical or similar, the top surface of the energy supply device has an interface for fastening the energy supply device to the power tool, as a result of which it differs from the substantially planar underside of the energy supply device. Such an interface is not present on the underside of the energy supply device, and therefore the top side and the underside of the energy supply device are substantially not of identical or similar design. In the context of the invention, the side with which the energy supply device is first introduced into the cavity in the power tool is preferably the front side of the energy supply device, while the rear side of the energy supply device in the introduced state is present in the region of the open side of the cavity. In a preferred refinement of the invention, this rear side of the energy supply device can wholly or partially form the rear side or rear wall of the power tool in the connected state. In another preferred embodiment of the invention, the rear side of the energy supply device can also form a rear wall of a main body of a power tool.

In the context of the invention, it is preferred to refer to the state in which the energy supply device is fastened to the power tool and in which the energy supply device supplies the power tool with electrical energy as an “introduced” or “inserted” state. The introduced or inserted state may also be referred to as a “working mode” or “operating state” of the system composed of energy supply device and power tool, since the power tool is enabled by the supply of electrical energy to perform work or to be operated. The state in which the energy supply device and the power tool are present separately from one another is referred to as a “disconnected” or “separate” state in the context of the invention. In this disconnected or separate state, the energy supply device can be connected to a charger, for example, in order to be charged.

The energy supply device can have on its top side in the front region those elements and components which allow electrical energy to be transmitted from the energy supply device to the power tool. In addition, means for data exchange between the energy supply device and the power tool can be provided. These can preferably be power and/or data contacts, which may be spring-mounted, for example. The spring mounting may be arranged, for example, in the region of the energy supply device and/or in the region of the power tool. After the energy supply device has been inserted, the power and/or data contacts come into operative connection with corresponding contacts of the power tool, such that a current flow and/or data exchange can be ensured.

In its rear region, the energy supply device has, on its surface, the interface with the locking mechanism with the at least one contact region with the contact material with the second density. The location at which the locking, that is to say fastening, of the energy supply device to the power tool is realized is preferably situated in said rear region of the energy supply device. In order to bring about the locking, the locking mechanism has at least one locking element which is mounted rotatably about an axis of rotation. The axis of rotation preferably runs in the third spatial direction or substantially parallel to the third axis of the virtual coordinate system which is used to describe the invention. The pivot point is preferably that point within the interface of the energy supply device through which the axis of rotation of the locking element runs.

The pivot point of the locking element may be arranged so as to precede a locking location in an insertion direction. The wording according to which the pivot point of the at least one locking element is arranged in front of a locking location in an insertion direction preferably means in the context of the invention that the pivot point of the locking element is for example arranged within the interface of the energy supply device not below the locking mechanism but so as to be offset in the “forward” spatial direction by a distance A. In other words, the distance between the power and/or data interface in the front region of the energy supply device and the pivot point is smaller than the distance between the power and/or data interface in the front region of the energy supply device and the locking mechanism in the rear region of the energy supply device. In other words again, the pivot point of the at least one locking element is closer to the power and/or data interface in the front region of the energy supply device than the locking mechanism of the energy supply device. In other words again, the pivot point of the locking element of the energy supply device is offset toward a center or a central region of the energy supply device, with the locking mechanism as a whole being at a smaller distance from the rear side of the energy supply device than the pivot point of the locking element of the energy supply device.

The second connection partner of the interface, which does not have the locking element, may have an undercut. The undercut constitutes an indentation, wherein the indentation is configured to receive the locking element of the interface. The undercuts and indentations may preferably be referred to as “counterpart contour of the opposite connection partner”. The interface may furthermore have a prestressing element, wherein the indentation constitutes a receiving space for the locking element when the locking element is pressed into the indentation by a prestress of the prestressing element. In other words, in the context of the invention, it is preferred that the prestressing element is configured to hold the locking element in the locking position. When the protruding region of the locking element snaps into the indentation of the second connection partner, the prestressing element can press the locking element into the indentation. During the unlocking, i.e. when it is sought to separate the energy supply device from the power tool, the prestressing element is relaxed as a result of the actuation of an actuating element, such that the locking element or its protruding region can slide out of the indentation. This sliding-out takes place as a result of the rotational movement of the locking element that the locking element is capable of. Here, the other or second connection partner may preferably be the power tool, wherein the locking element is part of the energy supply device.

It is preferred in the context of the invention that the locking element has a protruding region on a side opposite the pivot point, which region can enter into engagement with, or be received by, the indentation of the second connection partner. The protruding region of the locking element is received in the indentation preferably in the locking position, wherein the engagement of the locking element with the indentation of the second connection partner causes the first connection partner, on which the locking element is arranged, to be fixed or locked there. When the actuating element is actuated by a user, a protruding region of the actuating element enters an indentation of the locking element such that the locking element is moved in a “downward” spatial direction. As a result, the protruding region of the locking element is no longer situated in the indentation of the second connection partner, and the energy supply device is unlocked with respect to the power tool. In this unlocked state, the energy supply device can be removed from the power tool.

In the context of the invention, it is preferred that the energy supply device has a center of gravity that is arranged preferably substantially centrally or in the middle within the energy supply device. As a good approximation, the center of gravity of the energy supply device may be determined by ascertaining the point of intersection of the diagonals of the energy supply device.

A further advantage of an embodiment of the invention in which the interface has a locking element and an actuating element, wherein the at least one locking element is mounted rotatably about at least one spatial axis, wherein the spatial axis runs through a pivot point of the at least one locking element, wherein the pivot point of the at least one locking element precedes a locking location in an insertion direction, arises from the fact that the position of the pivot point of the locking element results in a self-reinforcing effect that can advantageously reinforce the locking action of the locking element. This advantage can be achieved in particular if the energy supply device comprises not only the locking element but also an actuating element, wherein the at least one actuating element is mounted rotatably about at least one spatial axis, wherein the spatial axis runs through a pivot point of the actuating element. It is preferred in the context of the invention that the energy supply device or its interface has at least one element for actuation (“actuating element”) by a user, wherein the at least one actuating element is mounted rotatably about at least one spatial axis, and the spatial axis runs through a pivot point of the actuating element. The spatial axis about which the axis of rotation of the actuating element may be rotatably mounted is preferably the same spatial axis about which the locking element of the locking mechanism is also rotatably mounted. The axis of rotation of the locking element and the axis of rotation of the actuating element are preferably substantially parallel to the third axis of the virtual coordinate system which is used to describe the invention. However, it may also be a different spatial direction, for example the first or the second axis of the virtual coordinate system. It is preferred in the context of the invention that the spatial axes about which the at least one locking element and the at least one actuating element are rotatably mounted are substantially identical. The locking mechanism is advantageously based on a rotary mounting of the locking element and the actuating element, and therefore an ergonomically unfavorable linear movement of the elements can advantageously be dispensed with.

The inventors have recognized that an interface locking arrangement which is designed in two parts and has a rotatably mounted actuating element and a rotatably mounted locking element, and also suitably placed pivot points, makes it possible to provide a particularly robust locking mechanism that is suitable for construction sites. This advantage is brought about in particular by the self-reinforcing interaction of the actuating element and the locking element.

In particular, with the invention, the energy supply device can be connected to the power tool in a functionally reliable, particularly play-free and robust way in a working mode. The locking mechanism is preferably designed so as to be movable or adjustable between a locking position and an unlocking position. In other words, the actuating element and the locking element can assume a locking position or an unlocking position, with an undercut blocking a last remaining degree of freedom of movement of the energy supply device in the locking position.

Tests have shown that the interface can accommodate surprisingly large forces without damaging occurring to the locking mechanism. This is advantageous in particular if the energy supply device is used in power tools in which intense vibrations occur during their operation. Furthermore, high forces can occur if the energy supply device falls or is dropped. In addition, it has been shown that the actuating element is particularly easily accessible and can be pressed down by a user using their thumb in an ergonomically favorable manner. Furthermore, the operating forces of the locking mechanism can be kept surprisingly low.

It is preferred in the context of the invention that the at least one locking element has a recess and the at least one actuating element has a protruding region, wherein the at least one locking element is configured to at least partially receive the at least one actuating element in an unlocking position (cf. FIG. 3). The energy supply device can be removed from the power tool in this unlocking position.

The interface may preferably have a prestressing element, wherein the prestressing element is configured to generate a prestress with which the locking element can be engaged with detent action into an indentation or an undercut of the second connection partner during the locking of the energy supply device (cf. FIG. 2: locking position).

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures.

In the figures:

FIG. 1 shows a view of a preferred embodiment of the locking mechanism FIG. 2 shows a detail view of the locking element and the of actuating element (locking position)

FIG. 3 shows a detail view of the locking element and the of actuating element

(unlocking position)

FIG. 4 shows a view of a preferred embodiment of a power tool

FIG. 5 shows a view of a preferred embodiment of the locking element

FIG. 6 shows a schematic side view of a preferred embodiment of the energy supply device

FIG. 7 shows a view of a preferred embodiment of the system.

### DETAILED DESCRIPTION

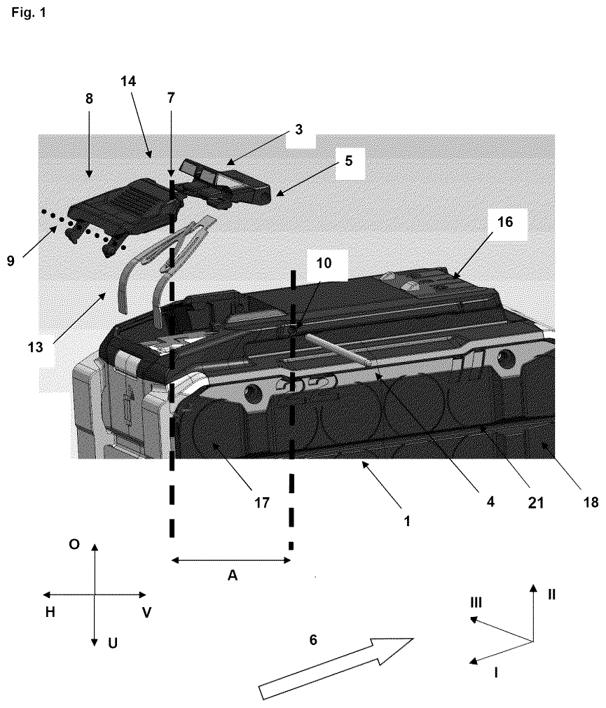

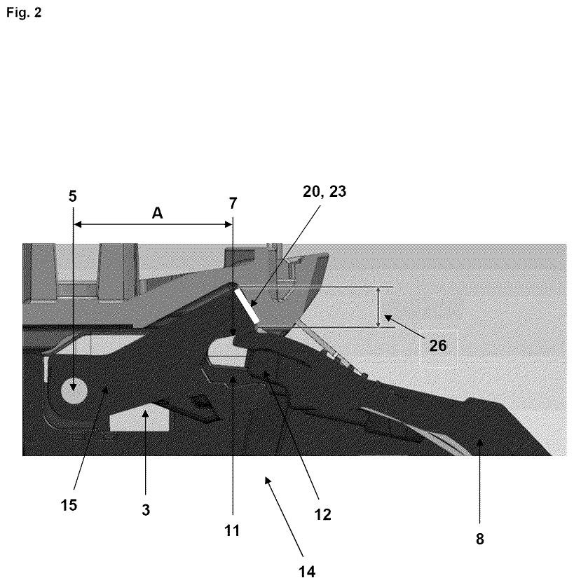

FIG. 1 shows a view of a preferred embodiment of the locking mechanism of an energy supply device 1. In the exemplary embodiments of the invention illustrated in FIGS. 1 to 4, the locking element 3 is in each case arranged on the energy supply device 1. It may however also be arranged on the power tool 2. In particular, a locking element 3, an actuating element 8 and a prestressing element 13 are illustrated in FIG. 1. The locking element 3 has a pivot point 5, the locking element 3 being mounted rotatably about the pivot point 5. A axis of rotation 4, which forms the center of the rotatability of the locking element 3, runs through the pivot point 5 of the locking element 3. The actuating element 8 has a pivot point 10, the actuating element 8 being mounted rotatably about the pivot point 10. A axis of rotation 9, which forms the center of the rotatability of the actuating element 8, runs through the pivot point 10 of the actuating element 8. The location 7 at which the locking element 3 and the actuating element 8 engage with one another to generate a locking action is referred to in the context of the invention as “locking location 7”.

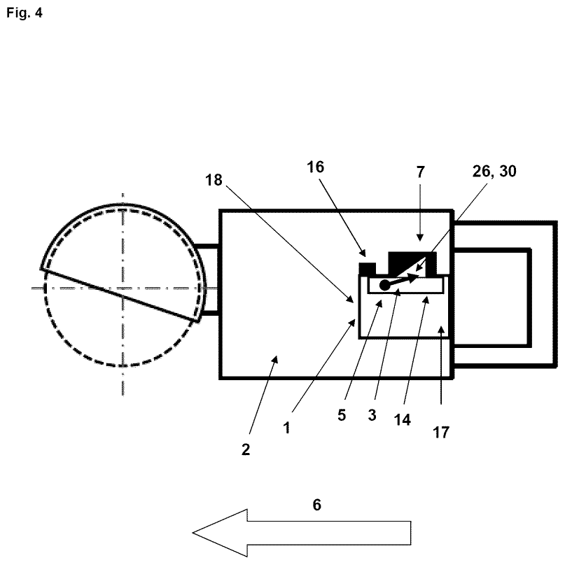

The energy supply device 1 is configured to supply electrical energy to a power tool 2 (see FIG. 4). For this purpose, the energy supply device 1 can be introduced into a cavity of the power tool 2. The energy supply device 1 is introduced into the power tool 2 along an insertion direction 6 which preferably coincides with a first axis I of a virtual coordinate system which is used to describe the invention. The virtual coordinate system also includes a second axis II and a third axis III. In the exemplary embodiment of the invention illustrated in FIG. 1, the axis of rotation 4 of the locking element 3 and the axis of rotation 9 of the actuating element 8 run substantially parallel to the third axis III of the virtual coordinate system.

As can be seen from FIG. 1, the pivot point 5 of the spatial axis 4 of the locking element 3 precedes the locking location 7 in the insertion direction 6. In the context of the invention, this preferably means that a distance A can be defined between the locking location 7 and the pivot point 5 of the spatial axis 4 of the locking element 3. This distance A is marked in FIG. 1 by an arrow with two arrowheads.

In order to connect the energy supply device 1 to the power tool 2, the energy supply device 1 has an interface 14, which preferably represents a mechanical interface. The interface 14 shown in FIG. 1 is present on a top side of the energy supply device 1. In a front region 18 of the energy supply device 1, the energy supply device 1 has a data and/or power interface 16, which can be used in the connected state to exchange data between the energy supply device 1 and the power tool 2 or to transfer electrical energy from the energy supply device 1 in the direction of the power tool 2. The energy supply device 1 has the locking mechanism with locking element 3 and actuating element 8 in a rear region 17. The energy supply device 1 can comprise a battery pack 21, which forms the lower region of the energy supply device 1.

If the locking element 3 is arranged on the energy supply device 1, the locking element 3 may have a base material 15 with a first density, wherein the locking element 3 has a first contact region 20 which, in a locking position, is in contact with a second contact region 19 of the other connection partner 2 or 1, wherein the first contact region 20 has a first contact material 23 and the second contact region 19 has a second contact material 25, wherein at least one of the contact materials 23, 25 has a second density.

FIG. 2 shows a detail view of the locking element 3 and of the actuating element 8. In particular, a locking position of the locking mechanism, in which the locking element 3 or a protruding region of the locking element 3 is received in an indentation 26 of the second connection partner, is shown in FIG. 2. The energy supply device 1 can thereby be locked in the power tool 2. In particular, a prestressing element 13 presses the locking element 3 into the indentation 26 of the second connection partner such that the locking element 3 is held securely and stably in the indentation 26. The locking element 3 illustrated in FIG. 2 has a first contact region 20, wherein the first contact region 20 comprises a first contact material 23. The contact material 23 may have a different, preferably greater density than a base material 15 of the locking element 3. By means of the preferred embodiment of the locking element 3 with at least two materials with different mechanical properties, which relate in particular to wear resistance, a particularly durable and robust interface 14 for connecting an energy supply device 1 and a power tool 2 can be provided. A contact region with a contact material with a second density may however also be present have on an opposite connection partner of the interface 14, which does not have the locking element 3.

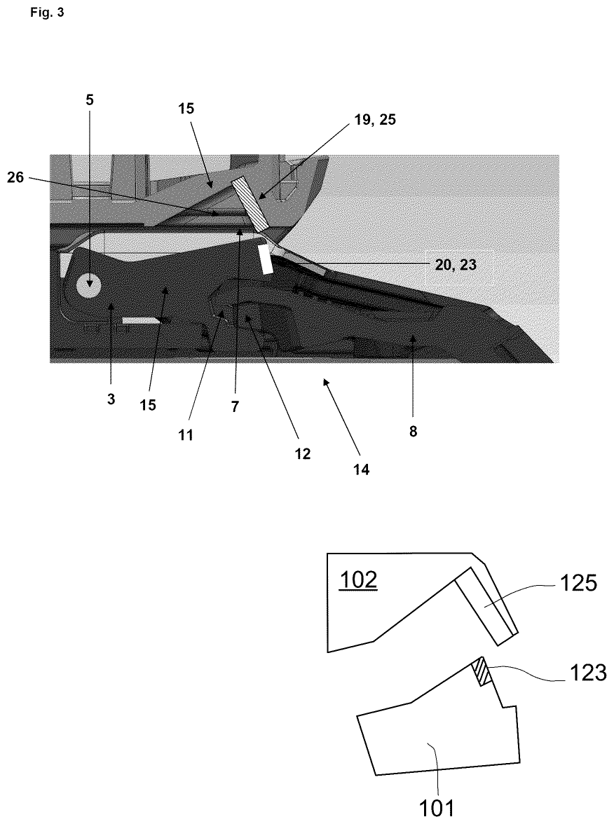

The locking element 3 may have a recess 11 which, in the event of unlocking (FIG. 3), can interact or engage with a protruding region 12 of the actuating element 8. The elements 3, 8 engage with one another at the locking location 7. A distance A exists between said locking location 7 and the pivot point 5 of the locking element 3, by which distance the pivot point 5 of the locking element 3 precedes the locking location 7 in the insertion direction 6. In the exemplary embodiment of the invention illustrated in FIG. 3, the locking element 3 is present on the energy supply device 1, wherein the locking element 3 has a first contact region 20 with a first contact material 23. On the power tool 2, there is arranged a second contact region 19 which has a second contact material 25, wherein at least one of the contact materials 23, 25 has a second density which is preferably greater than a first density of the base material 15. Both the energy supply device 1 and the power tool 2 may preferably comprise a base material 15, which may for example be a plastics material.

FIG. 4 shows a view of a preferred embodiment of a power tool 2. The power tool 2 may, in a conventional manner, comprise a tool, operating elements and/or handles. The power tool 2 may in particular also have a motor (not illustrated). The power tool 2 can be connected to an energy supply device 1 (“connected state”) in order to enable the energy supply device 1 to supply electrical energy to the power tool 2. The energy supply device 1 may have an interface 14 that can interact with a power tool 2. The energy supply device 1 has a data and/or power interface 16 on its top side. The data and/or power interface 16 may be arranged in a front region 18 of the energy supply device 1, whilst the locking mechanism is arranged in a rear region 17 of the energy supply device 1.

If the locking element 3 is part of the energy supply device 1, the power tool 2 may have an undercut 26, wherein the locking element 3 of the energy supply device 1 can be received by the undercut 26 of the power tool 2 in a locking position. The locking element 3 of the energy supply device 1 can rotate about its pivot point 5 and can thus be transferred between a locking position and an unlocking position. The locking mechanism may include a prestressing element 13, wherein the prestressing element 13 is configured to press the locking element 3 of the energy supply device 1 into the undercut 26 in the power tool 2. By actuation of an actuating element 8 of the locking mechanism (cf. FIGS. 2 and 3), the prestress of the prestressing element 13 can be released and the locking element 3 can be moved out of the undercut 26. This may for example take place by virtue of a tip of the locking element 3 moving out of the undercut 26 in the power tool 2 in a downward spatial direction U. The tip of the locking element 3 is preferably that region of the locking element 3 which is opposite the pivot point 5 of the locking element 3. In other words, the locking element 3 of the energy supply device 1 has a tip and a pivot point 5, wherein the tip and the pivot point 5 are arranged on opposite sides of the locking element 3. As can be seen from FIG. 4, the pivot point 5 of the locking element 3 precedes the locking location 7 in the insertion direction 6.

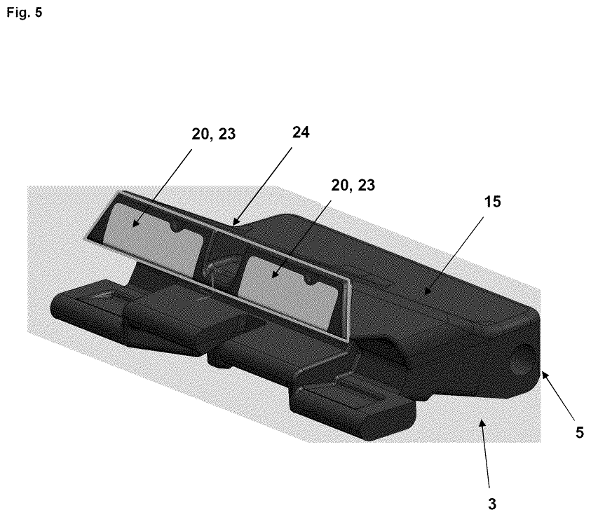

FIG. 5 shows a possible embodiment of the locking element 3, which may be configured for example as a so-called “hybrid pawl”. The locking element 3 shown in FIG. 5 may for example be arranged on the energy supply device 1. The term “hybrid” preferably relates to the fact that the locking element 3 may comprise at least two materials 15, 23, wherein a relatively large proportion of the locking element 3 is formed from a base material 15, and a relatively small proportion of the locking element 3 is formed from a first contact material 23. The first contact material 23 may for example be received in the form of inserts or insert parts in depressions of the base material 15 of the locking element 3. The first contact material 23 of the locking element 3 is preferably present in the contact region 20 of said locking element, wherein the contact region 20 of the locking element 3 may, in a locking position (cf. FIG. 2), be in contact with a second contact region 19 of the other connection partner of the interface 14. The second contact region 19 of the other connection partner may have a second contact material 25, wherein at least one of the contact materials 23, 25 has a second density. In the exemplary embodiments of the invention shown in the figures, the locking element 3 is normally part of the energy supply device 1 (“first connection partner of the interface 14”), whilst the power tool 2 forms the second connection partner of the interface 14.

The locking element 3 that is shown in FIG. 5 has two individual contact regions 20, which are each formed by an insert or insert part. The insert or insert part may comprise the first contact material 23. The protruding region of the locking element 3 forms an overall contact region 24, which is formed entirely or partially by the contact region 20. In the exemplary embodiment of the invention illustrated in FIG. 5, the two contact regions 20 do not completely fill the overall contact region 24, with relatively small regions that are not covered by contact material 23 rather remaining in the edge region of the overall contact region 24 or between the contact regions 20. In particular, the contact region 20 makes up a proportion in a range of more than 60%, preferably more than 70%, of the overall contact region 24 of the locking element 3. In FIG. 5, the overall contact region 24 is bordered by a gray line, or the position of said overall contact region is indicated by the gray line.

The locking element 3 may be mounted about a pivot point 5. In other words, the locking element 3 can rotate about its pivot point 5 and thus move from a locking position into an unlocking position or vice versa.

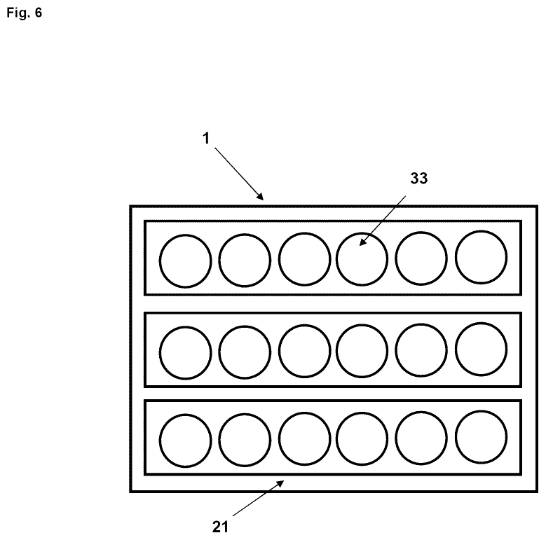

FIG. 6 shows a schematic side view of a preferred embodiment of the energy supply device 1. The energy supply device 1 shown in FIG. 6 has eighteen cells 33, wherein the eighteen cells 33 are arranged in three strings within the energy supply device 1. In particular, the cells 33 are symbolized by the circles, while the strings are symbolized by the elongate rectangles surrounding the circles (“cells 33”).

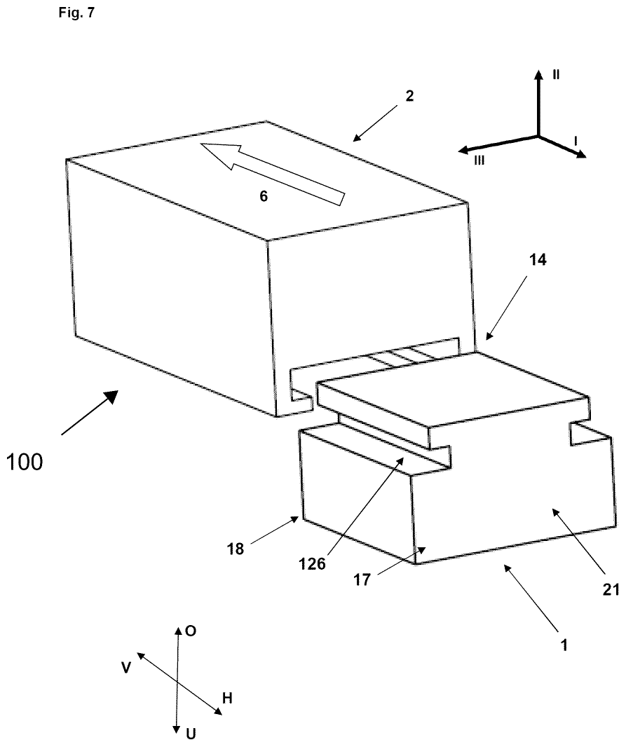

FIG. 7 shows a view of a preferred embodiment of the system 100. The figure shows an energy supply device 1 which can be introduced into a power tool 2 in order to supply the power tool 2 with electrical energy. The energy supply device 1 can, for example, be introduced into a cavity of the power tool 2 or into a receiving slot of the power tool 2, as shown in FIG. 7. The energy supply device 1 may comprise a battery pack 21 in which energy storage cells 33 (see FIG. 6) can be contained. The part-region of the interface 14 which belongs to the energy supply device 1 may be arranged in the upper region of the energy supply device 1. That part-region of the interface 14 which belongs to the energy supply device 1 may comprise the first contact region 20, which in turn comprises the first contact material 23. That part-region of the interface 14 which belongs to the energy supply device 1 may additionally comprise guide surfaces 126, wherein the guide surfaces 126 may be configured or oriented both horizontally and vertically. The interface 14 preferably comprises a linear guide, which can substantially facilitate insertion of the energy supply device 1 into the power tool 2.

The power tool 2 preferably has a part-region of the interface 14 that belongs to the power tool 2. This part-region of the interface 14 that belongs to the power tool 2 may be designed as a receiving device for receiving the part-region of the interface 14 that belongs to the energy supply device 1. It is preferred in the context of the invention that the part-regions of the interface 14 are designed to correspond in the sense that the energy supply device 1 can be introduced into the power tool 2 in order to subsequently be fastened there and supply the power tool 2 with electrical energy. The insertion direction 6 along which the energy supply device 1 can be inserted into the power tool 2 is represented in FIG. 7 by an arrow. The insertion direction 6 preferably coincides with a first spatial axis I of a virtual coordinate system which is used to describe the invention. The energy supply device 1 is configured to supply a power tool 2 with electrical energy. For this purpose, the energy supply device 1 can be introduced into a cavity of the power tool 2. The energy supply device 1 is introduced into the power tool 2 along an insertion direction 6 which preferably coincides with a first axis I of a virtual coordinate system which is used to describe the invention. The virtual coordinate system also includes a second axis II and a third axis III. The coordinate system illustrated in FIG. 7 with the three axes I, II and III corresponds to the coordinate system illustrated in FIG. 1.

In particular, that part-region of the interface 14 which belongs to the power tool 2 comprises the second contact region 19, which comprises the second contact material 25.

For the connection of the energy supply device 1 to the power tool 2, the energy supply device 1 has an interface 14, which is preferably a mechanical interface. The interface 14 shown in FIG. 7 is present on a top side of the energy supply device 1. The energy supply device 1 has a front region 18 and a rear region 17. The energy supply device 1 may comprise a battery pack 21, which forms the lower region of the energy supply device 1.

The interface 14 is designed in such a way that the interface 14 allows a relative movement of the power tool 2 and the energy supply device 1 in an insertion direction 6, wherein, in an inserted state, the first contact region 20 is in contact with the second contact region 19 in such a way that a relative movement between the power tool 2 and the energy supply device 1 in the other spatial directions is prevented. The energy supply device 1 can thus be held particularly securely and stably in the power tool 2, even when vibrations and shocks occur.

The insertion direction 6 preferably corresponds to the negative first spatial axis I of the virtual coordinate system which is used to describe the invention (cf. FIG. 1). The virtual coordinate system is likewise shown in FIG. 7, as is a direction arrow which indicates the spatial directions “forward V”, “rearward H”, “upward O” and “downward U” and denotes them with the corresponding letters: V, H, O and U.

### LIST OF REFERENCE SIGNS

1 Energy supply device
2 Power tool
3 Locking element
4 Spatial axis of the locking element
5 Pivot point of the spatial axis of the locking element
6 Insertion direction
7 Locking location
8 Actuating element
9 Spatial axis of the actuating element
10 Pivot point of the spatial axis of the actuating element
11 Recess of the locking element
12 Protruding region of the actuating element
13 Prestressing element
14 Interface of the energy supply device
15 Base material
16 Data and power interface
17 Rear region of the energy supply device
18 Front region of the energy supply device
19 Second contact region
20 First contact region
21 Battery pack
23 First contact material
24 Overall contact region
25 Second contact material
26 Undercut, indentation
30 Counterpart contour
31 Second energy supply device
33 Energy storage cell
100 System
126 Guide surfaces
A Distance between the locking location and the pivot point of the locking element
O Spatial direction “upward”
U Spatial direction “downward”
V Spatial direction “forward”
H Spatial direction “rearward”
I Axis 1
II Axis 2
III Axis 3

1-15. (canceled)

16. A system comprising:
a power tool; and
an energy supply device, the power tool detachably connectable to the energy supply device via an interface, the energy supply device and the power tool being connection partners of the interface;
one of the connection partners having a lock element for locking the energy supply device in the power tool, and the other connection partner having a counterpart contour as a stop for the lock element, wherein the lock element and the counterpart contour have a base material with a first density, wherein the lock element has a first contact region with a first contact material, wherein the first contact region, in a locking position, is in contact with a second contact region of the counterpart contour of the other connection partner, wherein the second contact region has a second contact material, wherein the first contact material or the second contact material has a second density.

17. The system as recited in claim 16 wherein the second density is greater than the first density.

18. The system as recited in claim 16 wherein the second density lies in a region of greater than 3.0 g/cm³.

19. The system as recited in claim 18 wherein the second density lies in a region of greater than 4 g/cm³.

20. The system as recited in claim 16 wherein the first density lies in a region of less than 3.0 g/cm³.

21. The system as recited in claim 20 wherein the first density lies in a region of less than 2 g/cm³.

22. The system as recited in claim 16 wherein a surface hardness of the first or second contact material having the second density lies in a region of greater than 90 HV.

23. The system as recited in claim 22 wherein the surface hardness lies in a region of greater than 100 HV.

24. The system as recited in claim 16 wherein the first or second contact material having the second density is a metal, a metal alloy or a metal coating.

25. The system as recited in claim 16 wherein the first or second contact material having the second density has a PREN value of greater than 10.

26. The system as recited in claim 25 wherein the PREN value is greater than 13.

27. The system as recited in claim 26 wherein the PREN value is greater than 15.

28. The system as recited in claim 16 wherein the contact region makes up a proportion in a range of more than 60% of an overall contact region of the lock element.

29. The system as recited in claim 28 wherein the proportion is more than 70% of the overall contact region of the lock element.

30. The system as recited in claim 16 wherein the lock element is arranged on the energy supply device or on the power tool.

31. The system as recited in claim 16 wherein the interface has not only the lock element but also an actuator for actuation by a user, wherein the lock element and the actuator form a lock mechanism, wherein the lock element or the actuator is mounted rotatably about at least one spatial axis, wherein the spatial axis runs through a pivot point of the lock element, wherein the pivot point of the lock element precedes a locking location in an insertion direction.

32. The system as recited in claim 16 wherein the first contact material has a volume, wherein the volume of the first contact material makes up a proportion in a range of less than 20% of a total volume of the lock element.

33. The system as recited in claim 28 wherein the proportion is less than 10%.

34. An energy supply device for use in a system as recited in claim 16, the energy supply device having an energy supply device contact region with an energy supply device contact material, wherein the energy supply device contact region is provided on the lock element or on the counterpart contour, wherein the lock element and the counterpart contour have a base material with the first density, wherein the energy supply device contact material has the second density.

35. The energy supply device as recited in claim 34 further comprising at least one energy storage cell, wherein the energy storage cell has an internal resistance DCR_I of less than 10 milliohms.

36. The energy supply device as recited in claim 35 wherein the at least one energy storage cell has a surface area A and a volume V, wherein a ratio A/V of surface area to volume is greater than six times the reciprocal of the cube root of the volume.

37. The energy supply device as recited in claim 36 wherein the ratio A/V is greater than eight times the reciprocal of the cube root of the volume.

38. The energy supply device as recited in claim 37 wherein the ratio A/V is greater than ten times the reciprocal of the cube root of the volume.
